(19) United States
(12) Patent Application Publication
(10) Pub. No.: US 2023/0222853 A1
(43) Pub. Date: Jul. 13, 2023

(54) DIAGNOSTIC TOOL WITH QR CODE GENERATING CAPABILITY

(71) Applicant: Innova Electronics Corporation, Irvine, CA (US)

(72) Inventors: David Rich, Huntington Beach, CA (US); Hoa Chau, Irvine, CA (US); Doug Constable, Irvine, CA (US)

(21) Appl. No.: 17/573,205

(22) Filed: Jan. 11, 2022

(51) Int. Cl. G07C 5/08; G06K 19/06; G06K 7/10; G06K 7/14

(52) U.S. Cl. CPC G07C 5/0808; G06K 19/06028; G06K 19/06037; G06K 7/10722; G06K 7/1413; G07C 2205/02

(57) ABSTRACT

A diagnostic tool for use in diagnosing a vehicle comprises a data interface for accessing an electronic control unit (ECU) of a vehicle and receiving diagnostic data from the ECU, a processor for generating a barcode encoding at least a portion of the received diagnostic data, and a display for displaying the generated barcode to allow for contactless transmission of the at least a portion of the received diagnostic data to an external device independent of any need for electrical or bidirectional communication with the external device. An external device may capture an image of the barcode, decode the at least a portion of the received diagnostic data based on the captured image of the barcode, transmit the decoded diagnostic data to a server, and receive vehicle condition information from the server based on the decoded diagnostic data.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

### Technical Field

The present disclosure relates to vehicle diagnostic products and services and, more particularly, to a diagnostic tool and related methods and systems for retrieving diagnostic information from a vehicle and enabling the transfer of such information to an external device.

### Related Art

There are many parties related to a vehicle diagnostics and repair transaction that may have a potential interest in accessing the underlying vehicle diagnostic data retrieved from the vehicle electronic control unit (ECU). In addition to diagnostic service providers who need access to current diagnostic data to determine the vehicle's condition, there may be repair service providers, auto parts stores, and/or roadside assistance service providers, for example, who may wish to use such diagnostic data to automatically identify relevant services, products, personnel, prices, promotions, and other aspects of a transaction, thus enabling them to better streamline processes and provide timely offerings. Access to current diagnostic data of a vehicle may also be useful during vehicle inspection for purposes of regulatory compliance or in connection with the sale of the vehicle.

Unfortunately, the state of the technology is such that a party interested in obtaining current vehicle diagnostic data must necessarily have a direct link to the vehicle, and there are many cases where the interested party cannot achieve the necessary direct link. For example, the interested party may lack the necessary tool for interfacing with the vehicle ECU, such as a scan tool, dongle, or restricted-access mobile application. As another example, the interior of the vehicle (including the OBD-II port, for example) may be inconvenient to access as in the case of a party providing a drive-through service, where efficiency is critical for keeping the drive-through line moving. As another example, the interior of the vehicle may be completely inaccessible such as in a case where the vehicle owner wishes to limit exposure to airborne pathogens during a pandemic. In these and other situations, due to the constraints of conventional technology, the interested party may have no choice but to obtain the diagnostic data indirectly, such as by referring to a past vehicle condition report that has already been provided to the vehicle owner or to another party. Such indirectly obtained diagnostic data may be unreliable due to human error (or even due to intentional mischaracterization). Moreover, such indirectly obtained diagnostic data is, by definition, outdated and may not be reflective of the current diagnostic condition of the vehicle.

Considering the above, there is a need for systems that enable the transfer of vehicle diagnostic data to various interested parties. The ideal system would allow for flexibility with respect to which parties may have access to current vehicle diagnostic data. The system should accommodate a variety of interested parties without requiring access to a scan tool or other specialized diagnostic equipment and irrespective of whether the party has convenient access to the interior of the vehicle at the time that the current diagnostic data is needed. The system should allow for the transfer of diagnostic data from a party who has access to proprietary diagnostic methodologies for analyzing the data to a party who does not, and vice versa, depending on the needs of the parties and the interests of the provider of such methodologies. Such transfers should ideally be possible even in cases where one or the other party lacks access to a communication network due to not having permission or having inadequate device capabilities.

### BRIEF SUMMARY

The present disclosure contemplates various systems, methods, and devices for overcoming the above drawbacks accompanying the related art. One aspect of the embodiments of the present disclosure is a diagnostic tool for use in diagnosing a vehicle. The diagnostic tool may comprise a data interface for accessing an electronic control unit (ECU) of a vehicle and receiving diagnostic data from the ECU, a processor for generating a barcode encoding at least a portion of the received diagnostic data, and a display for displaying the generated barcode to allow for contactless transmission of the at least a portion of the received diagnostic data to an external device independent of any need for electrical communication or bidirectional communication with the external device.

The barcode may encode a vehicle identification number (VIN) included in the received diagnostic data. The barcode may encode at least one selected from the group consisting of a diagnostic trouble code (DTC) included in the received diagnostic data, an odometer reading included in the received diagnostic data, vehicle sensor data included in the received diagnostic data, freeze frame data included in the received diagnostic data, and live data included in the received diagnostic data.

The processor may be operable to encrypt the at least a portion of the received diagnostic data, and the barcode may encode the encrypted data.

The barcode may be a two-dimensional barcode. The two-dimensional barcode may be a QR code.

The data interface may comprise an OBD-II connector.

The data interface may comprise a wireless transceiver.

The processor and the display may be housed in a handheld device. The handheld device may be a smartphone.

Another aspect of the embodiments of the present disclosure is a system for diagnosing a vehicle. The system may comprise the above diagnostic tool and a mobile communication device. The mobile communication device may have a camera for capturing an image of the barcode, a processor for decoding the at least a portion of the received diagnostic data based on the captured image of the barcode, and a wireless transceiver for transmitting the decoded diagnostic data to a server and receiving vehicle condition information from the server based on the decoded diagnostic data. The mobile communication device may further include a memory storing a mobile application operable to associate the decoded diagnostic data with a user profile corresponding to the vehicle.

Another aspect of the embodiments of the present disclosure is a system for diagnosing a vehicle. The system may comprise the above diagnostic tool and a mobile communication device. The mobile communication device may have a camera for capturing an image of the barcode and a processor for decoding the at least a portion of the received diagnostic data based on the captured image of the barcode and adding at least one item to a shopping cart based on the decoded diagnostic data. The at least one item may be selected from the group consisting of an auto part and a vehicle service order.

Another aspect of the embodiments of the present disclosure is a method of diagnosing a vehicle. The method may comprise accessing an electronic control unit (ECU) of a vehicle, receiving diagnostic data from the ECU, generating a barcode encoding at least a portion of the received diagnostic data, and displaying the generated barcode to allow for contactless transmission of the at least a portion of the received diagnostic data to an external device independent of any need for electrical communication or bidirectional communication with the external device.

The generating of the barcode may be performed by a processor housed in a handheld device. The displaying of the generated barcode may be performed on a display housed in the handheld device.

The generating of the barcode may be performed by an onboard processor of the vehicle. The displaying of the generated barcode may be performed on an onboard display of the vehicle.

The method may further comprise capturing an image of the barcode, decoding the at least a portion of the received diagnostic data based on the captured image of the barcode, transmitting the decoded diagnostic data to a server, and receiving vehicle condition information from the server based on the decoded diagnostic data.

The method may further comprise capturing an image of the barcode, decoding the at least a portion of the received diagnostic data based on the captured image of the barcode, and adding at least one item to a shopping cart based on the decoded diagnostic data. The at least one item may be selected from the group consisting of an auto part and a vehicle service order.

Another aspect of the embodiments of the present disclosure is a non-transitory program storage medium on which are stored instructions executable by a processor or programmable circuit to perform operations for diagnosing a vehicle. The operations may comprise accessing an electronic control unit (ECU) of a vehicle, receiving diagnostic data from the ECU, generating a barcode encoding at least a portion of the received diagnostic data, and displaying the generated barcode to allow for contactless transmission of the at least a portion of the received diagnostic data to an external device independent of any need for electrical communication or bidirectional communication with the external device.

Another aspect of the embodiments of the present disclosure is a system for diagnosing a vehicle. The system may comprise a handheld tool operable to access an electronic control unit (ECU) of a vehicle and receive diagnostic data from the ECU. The system may further comprise a kiosk having at least one display screen. The kiosk may be operable to receive the diagnostic data from the handheld tool, generate a barcode encoding at least a portion of the received diagnostic data, communicate the diagnostic data to a server, receive from the server a vehicle health report derived from the diagnostic data, and display the vehicle health report and the barcode on the at least one display screen of the kiosk.

The handheld tool may comprise a dongle attached to the kiosk. The handheld tool may comprise a scan tool that is connectable to the kiosk to transfer the diagnostic data from the handheld tool to the kiosk.

The system may comprise a mobile communication device. The mobile communication device may have a camera for capturing an image of the barcode, a processor for decoding the at least a portion of the received diagnostic data based on the captured image of the barcode, and a wireless transceiver for transmitting the decoded diagnostic data to a server and receiving vehicle condition information from the server based on the decoded diagnostic data.

Another aspect of the embodiments of the present disclosure is a system for diagnosing a vehicle. The system may comprise a handheld tool operable to access an electronic control unit (ECU) of a vehicle and receive diagnostic data from the ECU. The system may further comprise a kiosk having at least one display screen. The kiosk may be operable to receive the diagnostic data from the handheld tool, generate a barcode encoding at least a portion of the received diagnostic data, and display the barcode on the at least one display screen of the kiosk. The system may further comprise a mobile communication device. The mobile communication device may be operable to capture an image of the barcode, decode the at least a portion of the received diagnostic data based on the captured image of the barcode, and add at least one item to a shopping cart based on the decoded diagnostic data. The at least one item may be selected from the group consisting of an auto part and a vehicle service order.

The handheld tool may comprise a dongle attached to the kiosk. The handheld tool may comprise a scan tool that is connectable to the kiosk to transfer the diagnostic data from the handheld tool to the kiosk.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 shows a system for diagnosing a vehicle according to an embodiment of the present disclosure; and

FIG. 2 shows an example operational flow according to an embodiment of the present disclosure.

### DETAILED DESCRIPTION

The present disclosure encompasses various embodiments of systems, methods, and devices for use in vehicle diagnostics. The detailed description set forth below in connection with the appended drawings is intended as a description of several currently contemplated embodiments and is not intended to represent the only form in which the disclosed invention may be developed or utilized. The description sets forth the functions and features in connection with the illustrated embodiments. It is to be understood, however, that the same or equivalent functions may be accomplished by different embodiments that are also intended to be encompassed within the scope of the present disclosure. It is further understood that the use of relational terms such as first and second and the like are used solely to distinguish one from another entity without necessarily requiring or implying any actual such relationship or order between such entities.

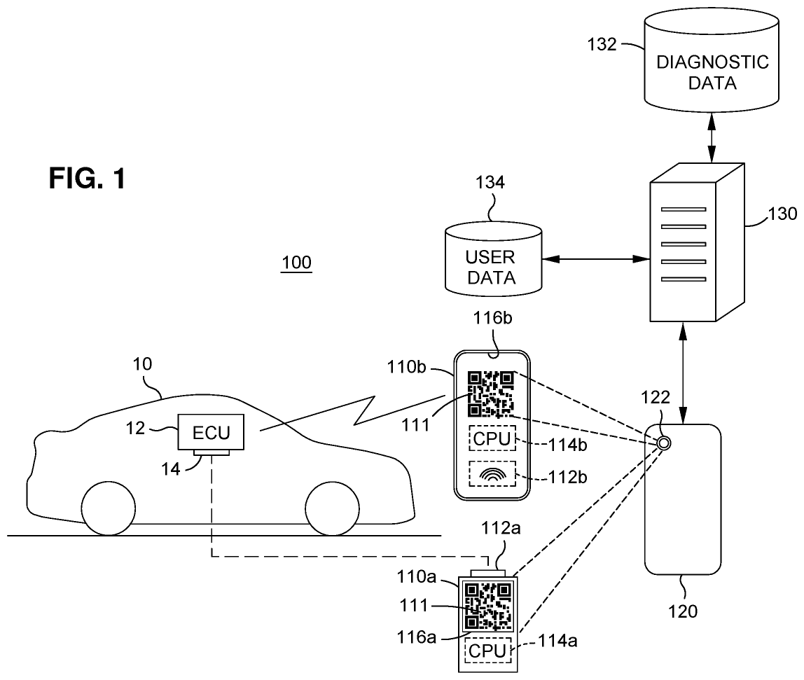

FIG. 1 shows a system 100 for diagnosing a vehicle according to an embodiment of the present disclosure. The system 100 may include a diagnostic tool 110 such as a dongle 110a and/or mobile communication device 110b (e.g., smartphone, tablet, etc.) that is capable of retrieving diagnostic data from a vehicle 10. Unlike conventional diagnostic tools, the diagnostic tool 110 may generate and display a barcode 111 (e.g., a QR code) encoding at least a portion of the diagnostic data retrieved from the vehicle 10. In this way, the system 100 may provide for the contactless transfer of the diagnostic data to an external device 120 by image capture or other means independent of any need for electrical communication or bidirectional communication with the external device 120. The transferred diagnostic data can then be used by the external device 120 for diagnostic analysis of the vehicle 10 (e.g., through communication with a server 130) or for a variety of other purposes depending on the particular implementation of the system 100. Exemplary diagnostic methods, including the use of such diagnostic data to arrive at a most likely root cause and a vehicle specific repair solution, are described in the following U.S. patents and patent application publications, each of which is owned by Innova Electronics Corporation of Irvine, Calif. (“Innova”): U.S. Pat. No. 6,807,469, entitled AUTO DIAGNOSTIC METHOD AND DEVICE, U.S. Pat. No. 6,925,368, entitled AUTO DIAGNOSTIC METHOD AND DEVICE, U.S. Pat. No. 7,620,484, entitled AUTOMOTIVE MOBILE DIAGNOSTICS, U.S. Pat. No. 8,068,951, entitled VEHICLE DIAGNOSTIC SYSTEM, U.S. Pat. No. 8,019,503, entitled AUTOMOTIVE DIAGNOSTIC AND REMEDIAL PROCESS, U.S. Pat. No. 8,370,018, entitled AUTOMOTIVE DIAGNOSTIC PROCESS, U.S. Pat. No. 8,909,416, entitled HANDHELD SCAN TOOL WITH FIXED SOLUTION CAPABILITY, U.S. Pat. No. 9,026,400, entitled DIAGNOSTIC PROCESS FOR HOME ELECTRONIC DEVICES, U.S. Pat. No. 9,177,428, entitled PREDICTIVE DIAGNOSTIC METHOD, U.S. Pat. No. 9,646,432, entitled HAND HELD DATA RETRIEVAL DEVICE WITH FIXED SOLUTION CAPABILITY, U.S. Pat. No. 9,824,507, entitled MOBILE DEVICE BASED VEHICLE DIAGNOSTIC SYSTEM, U.S. Pat. No. 10,643,403, entitled PREDICTIVE DIAGNOSTIC METHOD AND SYSTEM, U.S. Patent Application Pub. No. 2013/0297143, entitled METHOD OF PROCESSING VEHICLE DIAGNOSTIC DATA, U.S. Patent Application Pub. No. 2019/0304208, entitled SYSTEM AND METHOD FOR PROACTIVE VEHICLE DIAGNOSIS AND OPERATIONAL ALERT, and U.S. Patent Application Pub. No. 2019/0304213, entitled SYSTEM AND METHOD FOR PROACTIVE VEHICLE DIAGNOSIS AND OPERATIONAL ALERT, the entire contents of each of which is expressly incorporated herein by reference.

The diagnostic data encoded by the barcode 111 may include any information about the vehicle 10 that is retrievable from an electronic control unit (ECU) 12 of the vehicle 10, including the vehicle's identity (e.g., what specific vehicle or vehicle owner) and type (e.g., year, make, model, engine, trim), data representative of the vehicle's current or past condition, and/or state information of various vehicle systems that are in communication with the ECU 12. For example, the barcode 111 may encode a vehicle identification number (VIN), time/date, one or more confirmed, pending, and/or permanent diagnostic trouble codes (DTCs), an odometer reading, vehicle sensor data including I/M (inspection and maintenance) monitor data, freeze frame data, and/or live data of the vehicle 10 (e.g., throttle position, RPM, engine sensor readings such as oil temperature, etc.). The specific diagnostic information incorporated into the bar code 111 may be selected based on the amount of data that may be encoded into a particular bar code 111, e.g., the VIN and the confirmed DTCs. In some cases, multiple bar codes 111 may be generated to enable communication of larger amounts of data. Because it encodes the diagnostic data itself, the barcode 111 may serve as a machine-readable form of the vehicle's current diagnostic data that may be easily and accurately interpreted by an external device 120 without requiring any physical connection or the establishment of any bidirectional wireless communication session or electrical or electromagnetic signal. The external device 120 may simply capture an image of the barcode 111 using a standard camera 122 as may be included in any smartphone, tablet, or other mobile communication device, for example. The barcode 111 may be a two-dimensional barcode such as a QR code, for example. A standard QR code may store three kilobytes of data. A larger or smaller barcode 111 may be used, depending on the desired amount of diagnostic data to be encoded. Unlike conventional uses of a barcode, such as to encode an address of a diagnostic report stored on a server, the system 100 does not presuppose any capability of the diagnostic tool 110 to upload diagnostic data to a server in the first place or, indeed, to connect to or communicate bidirectionally with anything other than the vehicle 10.

Owing to the diagnostic tool 110 as described above, the vehicle diagnostic service industry may benefit from the effective separation of the scanning function from the diagnostic analysis function. Consider, for example, a business environment in which a diagnostic service provider has, through innovation and effort, developed an extensive database 132 of past diagnostic data (see FIG. 1) and a corresponding methodology of applying such diagnostic data to diagnose the condition of a vehicle 10 (e.g., using server 130). In order to protect its proprietary data and methodologies, the diagnostic service provider may choose to permit only one or a handful of repair service providers, auto parts stores, and roadside assistance service providers to access such data and methodologies. At the same time, however, the diagnostic service provider or another third-party device maker may wish to place the physical data access tools (e.g., scan tools, dongles, etc.) in the hands of the vehicle owners themselves, either because these tools have features that are also useful in the day-to-day operation of a vehicle or for the convenience of the vehicle owner (who can conduct a scan without relying on the diagnostic equipment of another and without inviting a technician into his/her vehicle, for example). Conventional technology struggles to accommodate these competing needs, as it becomes necessary for the vehicle owners themselves to be granted access to the proprietary data and methodologies of the diagnostic service provider in order to use their own data access tools.

The diagnostic tool 110 described herein solves this problem by producing a machine-readable barcode 111 encoding the vehicle's current diagnostic data. The vehicle owner may scan the vehicle 10 using his/her own diagnostic tool 110 to generate the barcode 111. The vehicle owner may then simply show the barcode 111 to the diagnostic service provider or one of the select few repair service providers, auto parts stores, or roadside assistance service providers (collectively, “providers”) who has been granted access to the proprietary database and associated methodologies (e.g., by subscription, license, contractual relationship, etc.). The provider may capture an image of the barcode 111 using any camera-equipped external device 120 (e.g., a mobile communication device) and upload the encoded diagnostic data to the server 130, which may, in turn, perform the proprietary diagnostic methodologies using past diagnostic data stored in the diagnostic database 132. The provider may then receive the result of the diagnostic analysis, such as a detailed diagnostic condition report or vehicle health report (VHR) of the vehicle 10. The provider may convey some or all of the information contained in the report to the vehicle owner or may use the information to automatically identify relevant services, products, personnel, prices, promotions, etc. for the benefit of the vehicle owner.

The automatic identification of relevant offerings using the data read from the barcode 111 may take a variety of forms depending on the operations of the particular service provider. The barcode 111 and/or a report derived therefrom may be used, for example, by online as well as physical stores to automatically populate a shopping cart or basket of items such as auto parts or service orders and/or to exchange and store an inspection and service log or history of a vehicle. As another example, a vehicle owner may arrive at a repair shop and the shop owner or technician may preview the barcode and/or report derived therefrom to order parts and repair the vehicle efficiently, possibly further accessing enhanced technician-only data that is available from the server 130 only with a subscription (or only with a premium level subscription).

In some cases, the provider may operate a drive-through or curbside auto parts store, where it is not necessary for the vehicle owner to exit his/her vehicle or to admit a technician into his/her vehicle (which may be desirable during a pandemic, for example). When it is the vehicle owner's turn in a queue, the vehicle owner may simply scan his/her vehicle 10 using the diagnostic tool 110 and present the barcode 111 to the provider (either to a human technician or to a kiosk-type camera or other scanner serving as the external device 120), which may even be done through a closed car window in some cases. Using the current diagnostic data of the vehicle 10 encoded in the barcode 111, the provider may then automatically identify relevant auto parts or other products or services, which may be loaded into the vehicle owner's trunk, for example, or shipped to the vehicle owner's residence, with minimal or no person-to-person contact between the vehicle owner and the provider.

In the above examples, the vehicle owner conducts the scan while the diagnostic service provider, repair service provider, auto parts store, or other provider has access to the server 130 and performs the diagnostic analysis. Beneficial use of the system 100 may also include the reverse situation, where a scan provider owns the diagnostic tool 110 that generates the barcode 111 and the vehicle owner him/herself is the party that accesses the proprietary data and methodologies represented by the server 130 and diagnostic database 132 shown in FIG. 1. In this scenario, the scan provider may operate a kiosk at a gas station or electric vehicle charging station, for example, and the diagnostic tool 110 may be a dongle 110a attached to the kiosk by a cable. In a self-service use case, the vehicle owner may drive up to the kiosk and connect the dongle 110a to his/her vehicle 10 to retrieve current diagnostic data and generate the barcode 111 containing the current diagnostic data. The vehicle owner may then use his/her own smartphone, which represents the external device 120 shown in FIG. 1 in this example, to capture an image of the barcode 111 and upload the received diagnostic data to the server 130. In this way, the vehicle owner him/herself need not own a data access device like the diagnostic tool 110 that can interface directly with the vehicle ECU 12. At the same time, the service provider who provides the diagnostic tool 110 (in this case the dongle 110a) need not have any relationship with the diagnostic service provider who operates the server 130 and diagnostic database 132 and may be restricted from accessing it. Each individual vehicle owner may instead have the needed subscription or other relationship with the diagnostic service provider granting access thereto.

Advantageously, in the above scenario, since the external device 120 that communicates with the server 130 is the vehicle owner's own personal device, the external device 120 may be already logged in to an application operated by the server 130 using the vehicle owner's private credentials. Thus, the diagnostic data received via the barcode 111 may be automatically associated with a user profile of the vehicle owner, and the data package uploaded by the external device 120 to the server 130 may contain information identifying the logged-in user profile in addition to the diagnostic data received from the barcode 111. The uploaded diagnostic data may be linked with the user profile as may be stored in a user data storage 134 in communication with the server 130. Linking the uploaded diagnostic data with a user profile of the vehicle owner may server a variety of purposes, including, for example, more accurately diagnosing the condition of the vehicle 10 with reference to past vehicle condition information stored in association with that particular user and vehicle 10, providing better targeted recommendations to the user in accordance with the user's preferences and settings, providing tiered levels of services (e.g., free, basic, premium) according to the user's subscription, etc. The user profile and associated mobile application may have any of the features described in Innova's U.S. patent application Ser. No. 17/458,154, filed Aug. 26, 2021 and entitled “System and Method for Selective Vehicle Data Retrieval,” the entire contents of which is expressly incorporated herein by reference.

Similar to the above kiosk example, a scan tool provider may loan a scan tool to the vehicle owner. Since the scan tool will only generate the barcode 111, it is not necessary for the scan tool to communicate any information to the server 130 identifying the vehicle owner (or to communicate with the server 130 at all). Upon receiving the diagnostic data from the barcode 111, the vehicle owner's own device 120 can upload identifying information such as a profile ID corresponding to a current login session on a mobile application in order to connect the retrieved diagnostic data with the vehicle owner's profile as described above.

In the above kiosk and scan tool loan examples, it is also contemplated that the barcode 111 may encode a portion of the retrieved diagnostic data but omit the VIN or other vehicle-identifying information (which may likewise not be retrieved from the ECU 12 in the first place). In this way, the privacy and security of the vehicle owner may be maintained. Upon receiving the diagnostic data from the barcode 111, the vehicle owner's own device 120 may append the VIN to the data package that is uploaded to the server 130. To this end, the VIN (which is unchanging and does not require a connection to the vehicle 10 to obtain) may be stored in the user's profile in the user data storage 134 and/or on the user's smartphone or other device 120. When the server 130 receives a data package from the device 120, the diagnostic data may be associated with the VIN for purposes of conducting the diagnostic analysis.

Another possibility is that a dealer of vehicles would generate and display the barcode 111 on a window sticker for consumers to easily view and/or online on a website in association with each vehicle 10. In this way, potential buyers of the vehicle 10 may view current and/or past condition of the vehicle 10 as well as the as-built assets of the particular vehicle 10, grading, and other items of interest to assist with evaluating the vehicle 10. A consumer could simply capture an image of or otherwise scan the barcode 111 to retrieve diagnostic data of the vehicle 10 on his/her own external device 120 (e.g., camera-enabled smartphone). The consumer may then communicate the diagnostic data to the server 130 using the external device 120 and, depending on the authorization of the consumer (e.g., as determined by subscription or, in some cases, as may be granted ad hoc by the vehicle owner), the consumer may receive a report from the server 130. In this regard, in order to enforce authorization rights and improve security, it is contemplated that the diagnostic data retrieved from the ECU 12 may be encrypted prior to being encoded in the barcode 111. The consumer or other party reading the barcode 111 may thus be unable to access the underlying diagnostic data without first decrypting the data in accordance with his/her authorization level.

More generally, the barcode 111 may encode encrypted diagnostic data in any of the above use cases. For example, when a vehicle owner scans his/her own vehicle and presents the generated barcode 111 to a repair service provider, parts store, or roadside assistance service provider, the provider may decode the barcode 111 (using image capture, for example) but may still be prevented from immediately accessing the diagnostic data as it is encrypted. In order to decrypt the diagnostic data, the provider may first need to communicate with the server 130 (which may either decrypt encrypted data that has been uploaded or may provide an appropriate decryption key). The authorization to decrypt the data may be granted by the vehicle owner, such as where the vehicle owner wishes to preserve privacy and security by limiting access to his/her diagnostic data. In this instance, the vehicle owner may receive a text message or other communication from the server 130 asking if access may be granted. As another scenario, the authorization to decrypt the data may be granted directly by the diagnostic service provider who operates the server 130, such as where the repair/parts/roadside assistance provider must first report the transaction to the server 130, pay a commission to the diagnostic service provider, etc. before proceeding with decrypting the diagnostic data.

As noted above, and as exemplified by the above uses cases, the system 100 does not require any capability of the diagnostic tool 110 to upload diagnostic data to the server 130 or, indeed, to connect to or communicate bidirectionally with anything other than the vehicle 10 or to produce any electrical or electromagnetic signal therefor. In a case where the diagnostic tool 110 is a dongle 110a, for example, it may not be necessary for the dongle 110a to have any bidirectional wireless communication functionality at all, and any related hardware such as a transceiver or antenna may be completely omitted. The data interface 112 of the dongle 110a may be in the form of an OBD-II connector 112a that establishes a wired connection with a corresponding OBD-II connector 14 of the vehicle 10 to access the ECU 12 and receive the diagnostic data. Along the same lines, in a case where the diagnostic tool 110 is a mobile communication device 110b such as a smartphone or tablet, there may be no need to use native wireless communication hardware for bidirectional communication with the external device 120 and the mobile communication device 110b may be offline or out of range of cellular or other wireless communication networks. For example, the system 100 might only make use of short-range wireless communication functionality of the mobile communication device 110b (e.g., Bluetooth, NFC, etc.) in order to access the electronic control unit (ECU) 12 of the vehicle 10 to receive the diagnostic data. The data interface 112 of the mobile communication device 110b may be in the form of a wireless transceiver 112b that establishes a wireless connection with the ECU 12 to receive the diagnostic data. In either case, the subsequent communication of the diagnostic data from the diagnostic tool 110 to the external device 120 (for communication with the server 130 or other purposes) may be done entirely via unidirectional image capture of the barcode 111 containing the diagnostic data. In this way, current diagnostic data may be freely transmitted to any interested party simply by showing the interested party the barcode 111 (e.g., at the same moment that the barcode 111 is generated or shortly after).

In addition to the data interface 112 such as the OBD-II connector 112a or wireless transceiver 112b, the diagnostic tool 110 may further have a processor 114a, 114b for generating the barcode 111 from a portion of the received diagnostic data and a display 116a, 116b for displaying the generated barcode 111 to allow for contactless transmission of the diagnostic data to the external device 120. In the case of the dongle 110a, the processor 114a may have little, if any, other functionality, perhaps supporting one or more basic modes of operation (e.g., automatically generate barcode 111 upon completion of diagnostic data retrieval from ECU 12, generate barcode 111 based on most recent diagnostic data retrieval at the touch of a button, automatically retrieve diagnostic data from ECU 12 upon being plugged in to vehicle 10, retrieve diagnostic data from ECU 12 at the touch of a button, etc.). The display 116a may be a liquid crystal display (LCD), for example, and may be monochrome in a case where the display 116a is only used to display the barcode 111. The dongle 110a can, therefore, be essentially a “dumb” device that is relatively inexpensive to make. In the case of the mobile communication device 110b (e.g., smartphone, tablet, etc.), the processor 114b and display 116b may be standard device components that may be used for a variety of purposes besides the contemplated generation and display of the barcode 111 in connection with the system 100. In this regard, in order for an otherwise general-purpose device to function as the envisioned mobile communication device 110b serving as the diagnostic tool 110, a user of the mobile communication device 110b may in some cases install an appropriate mobile application on the mobile communication device 110b. The mobile application may, for example, comprise instructions that are executable by the processor 114b to generate the barcode 111 and issue appropriate commands to a display driver to present the barcode 111 on the display 116b. Depending on the particular mobile application and/or preferences of the user, the generation and display of the barcode 111 may be performed on demand (e.g., in response to the user input), periodically, or in response to predefined events (e.g., when the vehicle 12 is in a particular location). The generation and display of the barcode 111 may be done automatically whenever diagnostic data is received by the ECU 12 or may be a separate function that is separately initiated.

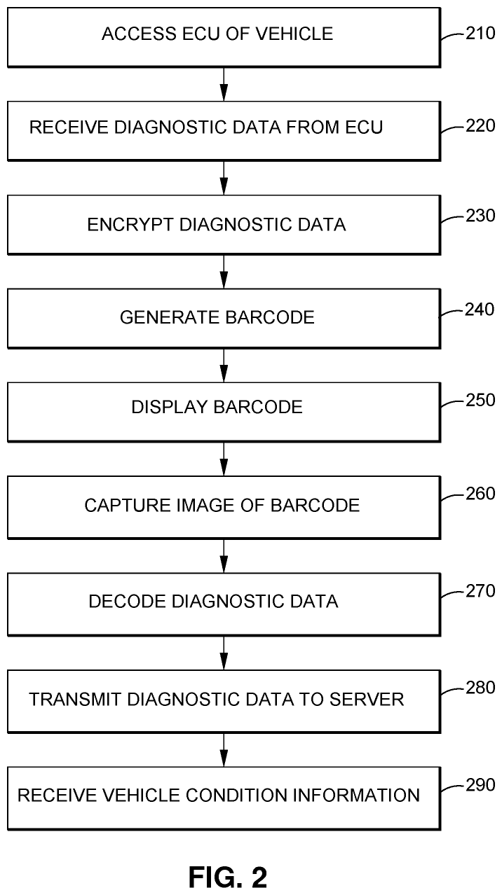

FIG. 2 shows an example operational flow according to an embodiment of the present disclosure. With reference to the system 100 shown in FIG. 1 by way of illustration, the operational flow may begin with accessing the ECU 12 of a vehicle 10 (step 210). For example, a diagnostic tool 110 as described herein may use a data interface 112 thereof to establish a communication link with the ECU 12, either by a hardwired connection such as via an OBD-II connector 112a as in the case of the dongle 110a or by a short-range wireless connection (e.g., Bluetooth) such as via a wireless transceiver 112b as in the case of the mobile communication device 110b. The diagnostic tool 110 may then receive diagnostic data of the vehicle 10 from the ECU 12 over the data interface 112, which may include a VIN of the vehicle 10 and/or DTCs and other types of data (step 220). In a scenario where the diagnostic tool 110 is a loaned scan tool, a dongle of a kiosk, or otherwise does not belong to the vehicle owner, it is contemplated that the VIN might in some cases specifically be omitted from the diagnostic data collected from the ECU 12. In this way, the scan can be performed by a third-party or publicly accessible device without jeopardizing the privacy of the vehicle owner. Once the diagnostic tool 110 has received the diagnostic data from the ECU 12, either automatically or in response to a user-initiated command or other trigger, the diagnostic tool 110 may generate a QR code or other barcode 111 encoding the diagnostic data (step 240) and display the generated barcode 111 on a display 116a, 116b (step 250). Optionally, the processor 114a, 114b of the diagnostic tool 110 may first encrypt the diagnostic data (step 230) and may generate the barcode 111 from the encrypted diagnostic data. By generating a barcode 111 that encodes encrypted diagnostic data, the diagnostic tool 110 may support contactless transmission of current diagnostic data of the vehicle 10 to virtually any external device 120 without needing to establish bidirectional communication or exchange any electric or electromagnetic signal with the external device 120, all while simultaneously enforcing any authorization rights imposed by the system 100.

The operational flow of FIG. 2 may continue with a sequence of operations that may be performed by the external device 120, beginning with capturing an image of the barcode 111 (step 260). For example, in a case where an ordinary smartphone serves as the external device 120, the external device 120 may capture an image of the barcode 111 using a built-in camera 122 thereof. Alternatively, the external device 120 may comprise a dedicated barcode reader rather than a general-purpose camera 122, either as a standalone handheld device or as a peripheral device in combination with a smartphone or computer (e.g., attached by USB). The external device 120 may then decode the diagnostic data that is encoded by the barcode 111 (step 270). If the diagnostic data was never encrypted, the external device 120 will now have access to the diagnostic data that was retrieved from the ECU 12 of the vehicle 10 (or at least the portion of such data that was encoded in the barcode 111 for the purpose of being conveyed to the external device 120). If, on the other hand, the diagnostic data was encrypted (either by the diagnostic tool 110 as describe above or, in some cases, by the vehicle 10), several possibilities are contemplated. As one possibility, the external device 120 may decrypt the diagnostic data using a decryption key that is already known by or contemporaneously or previously provided to the external device 120 (such as by the user of the diagnostic tool 110). Another possibility is that the external device 120 may obtain a decryption key from the server 130 after decoding the encrypted diagnostic data from the barcode 111. In this case, authorization to view and use the diagnostic data may be adjudicated by the server 130 that is controlled by the provider of the diagnostic database and methodologies (e.g., based on a subscription status of the user of the external device 120, who may be either a service/parts provider or the vehicle owner as discussed above). A third possibility, which might maintain the highest level of security, is for the external device 120 never to decrypt the diagnostic data and to simply upload the encrypted diagnostic data, once decoded from the barcode 111 (or even as an image of the barcode 111), to the server 130.

Thus, the diagnostic data, either in unencrypted or encrypted form, may then be transmitted by the external device 120 to the server 130 (step 280), for example, over a network such as the Internet using a wireless transceiver of the external device 120 (which may be a mobile communication device as described above). Together with the diagnostic data that was decoded from the barcode 111, the external device 120 may in some cases append additional information when uploading the data to the server 130. For example, especially in a case where the external device 120 is a device belonging to the vehicle owner as described above, the external device 120 may append an identifier of a user profile, such as an identifier associated with a current login session on a mobile application running on the external device 120. As another example, the external device 120 may append a VIN of the vehicle 10 in a case where the VIN is not included in the diagnostic data that was encoded in the barcode 111 (or in the diagnostic data that was retrieved from the ECU 12 in the first place). It is also contemplated that the external device 120 may append location data (e.g., from a GPS receiver located in the external device 120) in order to provide more detailed information to the server 130 and thus enhance the level of detail in the resulting report (e.g., to include nearby recommended service centers capable of repairing the particular vehicle 10 having the specific diagnostic condition). The server 130 may perform various proprietary methods of analysis using the diagnostic data (including the VIN of the vehicle 10), the past diagnostic data stored in the diagnostic database 132, and, in some cases, past vehicle condition information and/or user settings and preferences stored in association with the user profile in the user data storage 134. On the basis of such analysis, the server 130 may generate vehicle condition information, such as a report, that may be downloaded or otherwise received by the electronic device 120 (step 290). It is also contemplated that the user of the electronic device 120 may enter an email address or phone number to serve as a destination of an email or text message containing the report. In general, it is contemplated that a report generated by the server 130 may be held or maintained at a storage location in communication with the server 130, and that users may be able to access a page (e.g., via a URL) to view and/or organize all of the past inspection records associated with the user (e.g., associated with a user profile of the user). Users may also have the ability to share the information. For example, individual vehicle owners might share past records as part of an online vehicle transactions for the sake of transparency, or commercial/dealer users might share records as part of a referral to a service provider.

As described above, the system 100 does not require any capability of the diagnostic tool 110 to upload diagnostic data to the server 130. However, embodiments where such capability exists are also contemplated. To illustrate one such example use case, an auto parts store might provide customers with access to kiosks that allow the customers to inspect/scan their vehicles to obtain a vehicle health report (VHR). Diagnostic data may be gathered from a customer's vehicle 10 using a scan tool or dongle-connected tablet available for use at the store, either one that is attached to the kiosk by a cable or one that is a separate device (e.g., provided to the customer by a store clerk) and subsequently connected to the kiosk to fetch the VHR from a backend server (e.g., the server 130). In this instance, either or both of the scan tool/dongle/tablet and the kiosk may serve as the diagnostic tool 110 described herein, despite being able to communicate with the server 130 to acquire the VHR using conventional modalities such as wireless radio frequency transmission. The kiosk may then display the VHR on a display screen of the kiosk or tablet for viewing by the user. Owing to the disclosed innovations, such a kiosk may provide the user with a copy of the report without requiring the user to enter in an email or phone number as a destination of the report and without requiring the user's device to have access to the server (such as via a URL). The kiosk or tablet may simply display the QR code or other barcode 111 encoding the diagnostic data and/or VHR itself to quickly enable the transfer of the report from the kiosk/tablet screen directly to the user's phone. In addition, when a report is complete, the store staff could scan the displayed barcode 111 to ingest the shopping cart of the items needed directly to their point-of-sale (POS) terminals. This transfer would help staff sell and/or provide advice in relation to the necessary parts needed for service of the vehicle 10.

In the above examples, the diagnostic tool 110 is described as being a separate device from the vehicle 10. In this regard, the processor 114a, 114b and the display 116a, 116b of the diagnostic tool 110 may be housed in a handheld device, such as the dongle 110a or mobile communication device 110b described throughout the disclosure. The data interface 112a, 112b may likewise be partly or wholly housed within the handheld device, though it may protrude from the housing such as in the case of an OBD-II connector serving as the data interface 112a. However, the disclosure is not intended to be so limited. For example, it is also contemplated that the functionality of the diagnostic tool 110 may instead be partly or wholly on board the vehicle 10. For example, the dongle 110a may omit the display 116a and may instead interface with an onboard infotainment system of the vehicle 10 to display the barcode 110 on an onboard display of the vehicle 10 (which can then be captured for decoding by a camera 122 of an external device 120 in the same manner as described above). As another example, the diagnostic tool 110 may be omitted entirely and the entire functionality of accessing the ECU 12, receiving the diagnostic data from the ECU 12, generating the barcode 111, and displaying the generated barcode 111 may be performed on board the vehicle. In this regard, the generating of the barcode 111 (and optional encrypting) may be performed by an onboard processor of the vehicle 10, and the onboard display may likewise be used to display the barcode 111. It is envisioned that vehicles 10 may, depending on trim level, come equipped with such barcode generation functionality for the purpose of easily transmitting diagnostic data to external devices 120 as described throughout this disclosure.

The functionality described above in relation to the components of the system 100 including the diagnostic tool 110, external device 120, and server 130 shown in FIG. 2, as well as the operational flow described in relation to FIG. 2 and those of the mobile applications described throughout the disclosure, may be wholly or partly embodied in one or more computers including a processor (e.g. a CPU), a system memory (e.g. RAM), and a hard drive or other secondary storage device. The processor may execute one or more computer programs, which may be tangibly embodied along with an operating system in a computer-readable medium, e.g., the secondary storage device. The operating system and computer programs may be loaded from the secondary storage device into the system memory to be executed by the processor. The computer may further include a network interface for network communication between the computer and external devices (e.g. over the Internet), such as between the external device 120 and the server 130. To the extent that any of the described functionality may be performed at the server 130, the server 130 may comprise multiple physical servers and other computers that communicate with each other to perform the described functionality.

The above computer programs may comprise program instructions which, when executed by the processor, cause the processor to perform operations in accordance with the various embodiments of the present disclosure. The computer programs may be provided to the secondary storage by or otherwise reside on an external computer-readable medium such as a DVD-ROM, an optical recording medium such as a CD or Blu-ray Disk, a magneto-optic recording medium such as an MO, a semiconductor memory such as an IC card, a tape medium, a mechanically encoded medium such as a punch card, etc. Other examples of computer-readable media that may store programs in relation to the disclosed embodiments include a RAM or hard disk in a server system connected to a communication network such as a dedicated network or the Internet, with the program being provided to the computer via the network. Such program storage media may, in some embodiments, be non-transitory, thus excluding transitory signals per se, such as radio waves or other electromagnetic waves. Examples of program instructions stored on a computer-readable medium may include, in addition to code executable by a processor, state information for execution by programmable circuitry such as a field-programmable gate arrays (FPGA) or programmable logic array (PLA).

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A diagnostic tool for use in diagnosing a vehicle, the diagnostic tool comprising:
a data interface for accessing an electronic control unit (ECU) of a vehicle and receiving diagnostic data from the ECU;
a processor for generating a barcode encoding at least a portion of the received diagnostic data; and
a display for displaying the generated barcode to allow for contactless transmission of the at least a portion of the received diagnostic data to an external device independent of any need for electrical communication with the external device.

2. The diagnostic tool of claim 1, wherein the barcode encodes a vehicle identification number (VIN) included in the received diagnostic data.

3. The diagnostic tool of claim 2, wherein the barcode further encodes at least one selected from the group consisting of a diagnostic trouble code (DTC) included in the received diagnostic data, an odometer reading included in the received diagnostic data, vehicle sensor data included in the received diagnostic data, freeze frame data included in the received diagnostic data, and live data included in the received diagnostic data.

4. The diagnostic tool of claim 1, wherein the barcode encodes a diagnostic trouble code (DTC) included in the received diagnostic data.

5. The diagnostic tool of claim 1, wherein the barcode encodes an odometer reading included in the received diagnostic data.

6. The diagnostic tool of claim 1, wherein the barcode encodes vehicle sensor data included in the received diagnostic data.

7. The diagnostic tool of claim 1, wherein the barcode encodes freeze frame data included in the received diagnostic data.

8. The diagnostic tool of claim 1, wherein the barcode encodes live data included in the received diagnostic data.

9. The diagnostic tool of claim 1, wherein the processor is operable to encrypt the at least a portion of the received diagnostic data, the barcode encoding the encrypted data.

10. The diagnostic tool of claim 1, wherein the barcode is a two-dimensional barcode.

11. The diagnostic tool of claim 10, wherein the two-dimensional barcode is a QR code.

12. The diagnostic tool of claim 1, wherein the data interface comprises an OBD-II connector.

13. The diagnostic tool of claim 1, wherein the data interface comprises a wireless transceiver.

14. The diagnostic tool of claim 1, wherein the processor and the display are housed in a handheld device.

15. The diagnostic tool of claim 14, wherein the handheld device is a smartphone.

16. The diagnostic tool of claim 15, wherein the data interface comprises a wireless transceiver disposed in the smartphone and operative to communicate with the ECU.

17. The diagnostic tool of claim 15, wherein the data interface comprises a wireless transceiver disposed in the smartphone and operative to communicate with a dongle electrically connected to the ECU.

18. The diagnostic tool of claim 1, wherein the display of the generated barcode allows for contactless transmission of the at least a portion of the received diagnostic data to the external device independent of any need for bidirectional communication with the external device.

19. A system for diagnosing a vehicle, the system comprising:
the diagnostic tool of claim 1; and
a mobile communication device, the mobile communication device having a camera for capturing an image of the barcode, a processor for decoding the at least a portion of the received diagnostic data based on the captured image of the barcode, and a wireless transceiver for transmitting the decoded diagnostic data to a server and receiving vehicle condition information from the server based on the decoded diagnostic data.

20. The system of claim 19, wherein the mobile communication device further includes a memory storing a mobile application operable to associate the decoded diagnostic data with a user profile corresponding to the vehicle.

21. A system for diagnosing a vehicle, the system comprising:
the diagnostic tool of claim 19; and
a mobile communication device, the mobile communication device having a camera for capturing an image of the barcode and a processor for decoding the at least a portion of the received diagnostic data based on the captured image of the barcode and adding at least one item to a shopping cart based on the decoded diagnostic data, the at least one item selected from the group consisting of an auto part and a vehicle service order.

22. A method of diagnosing a vehicle, the method comprising:
accessing an electronic control unit (ECU) of a vehicle;
receiving diagnostic data from the ECU;
generating a barcode encoding at least a portion of the received diagnostic data; and
displaying the generated barcode to allow for contactless transmission of the at least a portion of the received diagnostic data to an external device independent of any need for electrical communication with the external device.

23. The method of claim 22, wherein said generating is performed by a processor housed in a handheld device.

24. The method of claim 23, wherein said displaying is performed on a display housed in the handheld device.

25. The method of claim 22, wherein said generating is performed by an onboard processor of the vehicle.

26. The method of claim 25, wherein said displaying is performed on an onboard display of the vehicle.

27. The method of claim 22, wherein said displaying the generated barcode allows for contactless transmission of the at least a portion of the received diagnostic data to the external device independent of any need for bidirectional communication with the external device.

28. The method of claim 22, further comprising:
capturing an image of the barcode;
decoding the at least a portion of the received diagnostic data based on the captured image of the barcode;
transmitting the decoded diagnostic data to a server; and
receiving vehicle condition information from the server based on the decoded diagnostic data.

29. The method of claim 22, further comprising:
capturing an image of the barcode;
decoding the at least a portion of the received diagnostic data based on the captured image of the barcode; and
adding at least one item to a shopping cart based on the decoded diagnostic data, the at least one item selected from the group consisting of an auto part and a vehicle service order.

30. A non-transitory program storage medium on which are stored instructions executable by a processor or programmable circuit to perform operations for diagnosing a vehicle, the operations comprising:
accessing an electronic control unit (ECU) of a vehicle;
receiving diagnostic data from the ECU;
generating a barcode encoding at least a portion of the received diagnostic data; and
displaying the generated barcode to allow for contactless transmission of the at least a portion of the received diagnostic data to an external device independent of any need for electrical communication with the external device.

31. The non-transitory program storage medium of claim 30, wherein said displaying the generated barcode allows for contactless transmission of the at least a portion of the received diagnostic data to the external device independent of any need for bidirectional communication with the external device.

32. A system for diagnosing a vehicle, the system comprising:
a handheld tool operable to access an electronic control unit (ECU) of a vehicle and receive diagnostic data from the ECU; and
a kiosk having at least one display screen, the kiosk operable to receive the diagnostic data from the handheld tool, generate a barcode encoding at least a portion of the received diagnostic data, communicate the diagnostic data to a server, receive from the server a vehicle health report derived from the diagnostic data, and display the vehicle health report and the barcode on the at least one display screen of the kiosk.

33. The system of claim 32, wherein the handheld tool comprises a dongle attached to the kiosk.

34. The system of claim 32, wherein the handheld tool comprises a scan tool that is connectable to the kiosk to transfer the diagnostic data from the handheld tool to the kiosk.

35. The system of claim 32, further comprising a mobile communication device, the mobile communication device having a camera for capturing an image of the barcode, a processor for decoding the at least a portion of the received diagnostic data based on the captured image of the barcode, and a wireless transceiver for transmitting the decoded diagnostic data to a server and receiving vehicle condition information from the server based on the decoded diagnostic data.

36. A system for diagnosing a vehicle, the system comprising:
a handheld tool operable to access an electronic control unit (ECU) of a vehicle and receive diagnostic data from the ECU;
a kiosk having at least one display screen, the kiosk operable to receive the diagnostic data from the handheld tool, generate a barcode encoding at least a portion of the received diagnostic data, and display the barcode on the at least one display screen of the kiosk; and
a mobile communication device, the mobile communication device operable to capture an image of the barcode, decode the at least a portion of the received diagnostic data based on the captured image of the barcode, and add at least one item to a shopping cart based on the decoded diagnostic data, the at least one item selected from the group consisting of an auto part and a vehicle service order.

37. The system of claim 36, wherein the handheld tool comprises a dongle attached to the kiosk.

38. The system of claim 36, wherein the handheld tool comprises a scan tool that is connectable to the kiosk to transfer the diagnostic data from the handheld tool to the kiosk.
